(19) United States
(12) Patent Application Publication
(10) Pub. No.: US 2015/0078564 A1
(43) Pub. Date: Mar. 19, 2015

(54) ECHO CANCELLATION ALGORITHM FOR LONG DELAYED ECHO

(71) Applicants: Yongfang Guo, Sunnyvale, CA (US); Xintian E. Lin, Palo Alto, CA (US); Ulun Karacaoglu, San Diego, CA (US); Narayan Biswal, Folsom, CA (US)

(72) Inventors: Yongfang Guo, Sunnyvale, CA (US); Xintian E. Lin, Palo Alto, CA (US); Ulun Karacaoglu, San Diego, CA (US); Narayan Biswal, Folsom, CA (US)

(21) Appl. No.: 13/995,560

(22) PCT Filed: Jun. 8, 2012
(86) PCT No.: PCT/US12/41599

§ 371 Date: Jun. 19, 2013

(51) Int. Cl. G10L 21/0208

(52) U.S. Cl. CPC G10L 21/0208; G10L 2021/02082
USPC 381/66

(57) ABSTRACT

This document discloses one or more systems, apparatuses, methods, etc. for implementing an echo cancellation algorithm for long delayed echo that is created during a wire or wireless voice communications. In an implementation, a WiDi feature in a device during the wire or wireless voice communications may add an additional echo delay in addition to channel multipath delay when an audio sound signal travels from a WiDi component to a microphone of the device. In this implementation, a separate delay estimator is configured to estimate total delay. The estimated total delay is fed back to an adoptive filter component for long delay echo cancellation.

### BACKGROUND

Echo cancellers are commonly used to cancel echoes in communications circuits to minimize signal interference that may distract users and cause a reduction in quality of communication. Since an echo delay path in the communication circuits may create long delay intervals, an echo cancellation filter should be capable of modeling an impulse response characteristic equivalent to long delay intervals. In other words, the longer the delay intervals, the more complex would be the corresponding echo cancellation filter needed to cancel the echoes.

Currently, wireless display (WiDi) technology may be built into processors of wireless devices to allow wireless streaming of audio and video signals from the wireless device to a compatible television (TV) or display device. For example, the wireless streaming of the audio and the video signal is implemented through a WiFi link. The WiDi technology makes the audio and video streaming more convenient and a display may be made available to a wider audience. However, the WiDi technology may introduce an additional delay that current echo cancellation filters may not address. Accordingly, a solution for the long delayed echo, such as the long delayed echo created by the WiDi technology may be implemented in the current wireless devices to save costs.

### BRIEF DESCRIPTION OF THE DRAWINGS

FIG. 1 illustrates an example echo environment between devices.

FIG. 2 illustrates an example direct acoustic path echo at a near-end device.

FIG. 3 illustrates an exemplary direct acoustic path echo at a near-end device that includes WiDi features.

FIG. 4 illustrates an exemplary cross-correlation estimation that is used to estimate delay by delay estimator.

FIG. 5 is an example process chart illustrating an example method for loop for implementing echo cancellation algorithm for long delayed echo.

FIG. 6 is an example computing device to implement echo cancellation algorithm for long delayed echo.

The following Detailed Description is provided with reference to the accompanying figures. In the figures, the left-most digit(s) of a reference number usually identifies the figure in which the reference number first appears. The use of the same reference numbers in different figures indicates similar or identical items.

### DETAILED DESCRIPTION

This document discloses one or more systems, apparatuses, methods, etc. for implementing an echo cancellation algorithm for a long delayed echo in a communication circuit and, more particularly, the long delayed echo that is created during a wire or wireless voice communications. In an implementation, a WiDi feature in a device during the wire or wireless voice communications may add an additional echo delay. For example, the WiDi feature of the device transmits an audio electrical signal from the device to a television (TV) or display device through a wireless or WiFi link. In this example, the display device converts the audio electrical signal into an audio sound signal that may be reflected by surrounding environment and picked-up by a microphone of the device. As a result, a long delayed echo is produced at the device due to the WiFi link path and the path travelled by the audio sound signal from the display device to the microphone of the device.

In an implementation, a delay estimator component is configured to estimate amount of the long delayed echo that includes the delay incurred from the device to the display device and from the display device to the microphone of the device. In this implementation, the delay estimator component performs cross-correlations of a received signal (e.g., audio electrical signal) and resulting echo signal received through the microphone of the device. The estimated amount of the long delayed echo is inserted to a standard echo cancellation system through a delay insertion component. The delay insertion component may act as an interface to the delay estimator component for implementing the echo cancellation algorithm for the long delayed echo.

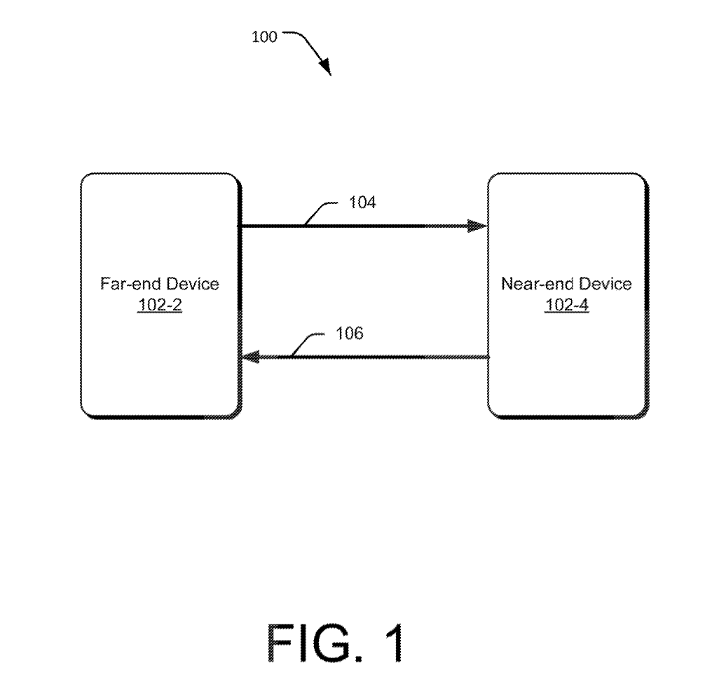

FIG. 1 illustrates an example echo environment 100 between devices 102. In an implementation, a far-end device 102-2 conducts a wired or wireless voice communications with a near-end device 102-4. The wired or wireless voice communications may include (but is not limited to) audio conference calls with WiDi, hands-free car phone systems, a standard telephone or cell-phone in hands-free mode, and the like. In this implementation, the far-end device 102-2 includes a user (not shown) who is initiating and delivering an audio conversation to another user (not shown) at the near-end device 102-4. The audio conversation may be delivered through a wired or wireless link 104 from the far-end device 102-2 to the near-end device 102-4. At the near-end device 102-4, a loudspeaker component (not shown) may generate an audio sound signal that bounces back (e.g., due to surrounding environment) and re-enters into a microphone component (not shown) of the near-end device 102-4. The re-entering audio sound signal may be referred to as a direct acoustic path echo. The direct acoustic path echo may be transmitted as unwanted signal (not shown) through a wired or wireless link 106 and if not cancelled, the unwanted signal may be heard or interfere at the far-end device 102-2. Due to slight round-trip transmission delay, the direct acoustic path echo may create distraction between users (not shown) of the device 102 during the wired or wireless voice communications.

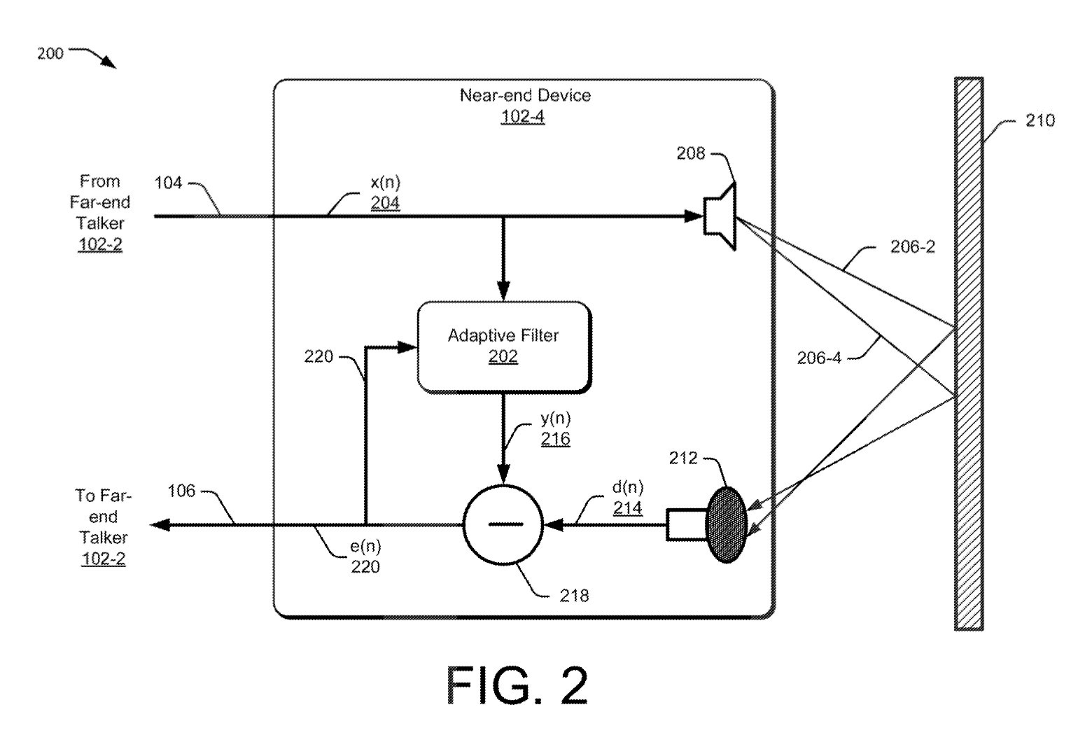

FIG. 2 illustrates an example direct acoustic path echo 200 at the near-end device 102-4. In an implementation, such as in a video conferencing system (e.g., Skype™), an acoustic echo canceller at the near-end device 102-4 may use an adaptive filter component 202 to cancel echoes. For example, a signal x(n) 204 may carry an electrical audio signal that includes voice conversations from the user (not shown) at the far-end device 102-2 through the link 104. The electrical audio signal may be transformed into an audio sound signal 206 by a loudspeaker 208 at the near-end device 102-4. The audio sound signal 206 may be reflected back by the surrounding environment (e.g., wall 210) to a microphone 212 of the near-end device 102-4. For example, the audio sound signal signals 206-2 and 206-4 are reflected through different paths by the wall 210. Other multiple paths (not shown) may be traversed by the audio sound signal 206 and may find its way back to the microphone 212. Since the audio sound signal 206 travels through the different paths (e.g., audio sound signal paths 206-2 and 206-4), the audio sound signal 206 may be picked-up by the microphone 212 at slightly different time. A signal d(n) 214 may represent the picked-up audio sound signal signals that may be transmitted back to the far-end device 102-4 through the link 106 if not cancelled. The signal d(n) 214 may include the unwanted signal that may be re-transmitted back and interferes with the user (not shown) at the far-end device 102-4.

To minimize effect of the signal d(n) 214, the adaptive filter component 202 may process the signal x(n) 204 using adaptive filter algorithms, such as least mean squares (LMS) algorithm, normalized LMS (NLMS) algorithm, or root mean square (RMS) algorithm to create an output y(n) 216. For example, the adaptive filter component 202 may algorithmically alter its parameters in order to minimize a function of the difference between the signal d(n) 214 and its actual output y (n) 216 through a differential component 218. At each iteration, an error signal e(n) 220 is fed back into the adaptive filter component 202 where the filter characteristics are altered accordingly. The output y(n) 216, when combined or subtracted from the d(n) 214 through the differential component 218 may result to elimination or cancellation of the unwanted signal d(n) 214. The adaptive filter component 202 may further include a self-adjusting transfer function according to an optimization algorithm that is driven by the error signal e(n) 220. The adaptive filter component 202 may use the error signal e(n) 220 to refine its transfer function to match changing parameters in the signals x(n) 204 and d(n) 214.

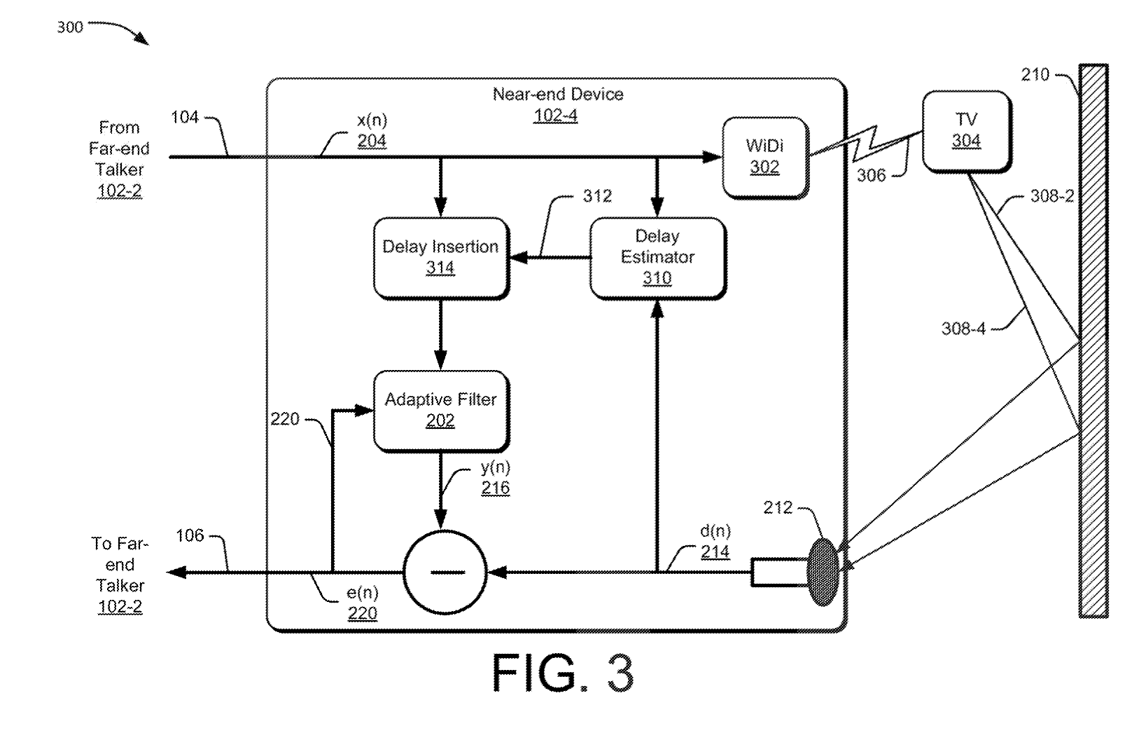

FIG. 3 illustrates an example direct acoustic path echo 300 at the near-end device 102-4 that includes WiDi features. In an implementation, a tail length (i.e., length of impulse response of transfer function) of the adaptive filter component 202 may determine how much echo (e.g., d(n) 214) may be cancelled. For example, a an echo canceller that uses the adaptive filter component 202 may cancel the echo that includes a delay of up to 60 msec (i.e., 10 meters distance). In this example, the adaptive filter component 202 may require about 1000 taps for 16 KHz audio sampling rate. The “tap” may refer to different delays experienced by the reflected audio signal 206 (of FIG. 2) when processed by the adaptive filter component 202. In an implementation, a WiDi feature, such as use of WiDi 302 that streams an electrical audio signal (not shown) to a TV or display device 304 through a WiFi link 306 may introduce an additional delay. The additional delay may be created by the path—WiFi link 306. Adding the additional delay to channel multipath delay created when audio signal 308 is picked-up by the microphone 212 may total to around 250 msecs as an example. The audio signal 308 is produced by a loudspeaker (not shown) at the TV or display device 304.

Using the adaptive filter component 202 alone to cancel the total amount of delay (i.e., around 250 msecs) may require around 5000 taps to process the total amount of delay at the same audio sampling rate of 16 KHz. In other words, the adaptive filter component 202 may create an impractical filter response output due to the number of taps (i.e., 5000 taps) that are required to process the total amount of delay. As the number of taps increases, the adaptive filter component 202 may become unstable in addition to becoming complex and expensive to implement.

In an implementation, a delay estimator 310 is configured to first estimate a total amount of estimated delay (i.e., delay 312) introduced by the WiFi link 306 and the channel multipath travelled by the audio signal 308. In this implementation, the signals x(n) 204 and d(n) 214 are inputs to the delay estimator 310. The delay estimator 310 may estimate the delay by performing an algorithm that searches a peak (not shown) of cross-correlations between the signals x(n) 204 and d(n) 214. The peak of the cross-correlations between the signals x(n) 204 and d(n) 214 may correspond to the estimated delay (i.e., delay 312). In an implementation, the estimation performed by the delay estimator 310 may include two steps. For example, a first search includes a coarse search with a larger step size, such as at least 6.25 ms. The coarse search of the step size 6.25 ms is taken from 100 samples for 16 KHz audio sampling rate. The step size 6.25 ms is used as an incremental rate for searching the peak cross-correlation between the signals x(n) 204 and d(n) 214. After obtaining the peak cross-correlation on the first coarse search, a second search i.e., a fine search, is performed on the searched peak cross-correlation (from the first coarse search). The fine search may be implemented by introducing a different and/or smaller delay of at least 62.5 μs. The fine search increments the delay by 62.5 μs until a maximum cross-correlation is determined. In an implementation, the maximum cross-correlation is the delay 312 that is fed to a delay insertion component 314. The delay insertion component 314 may act as an interface to the delay 312 prior to regular performance of echo cancellation algorithm by the adaptive filter component 202. The regular performance of the echo cancellation algorithm may exclude presence of the long tail length in the transfer function of the adaptive filter component 202.

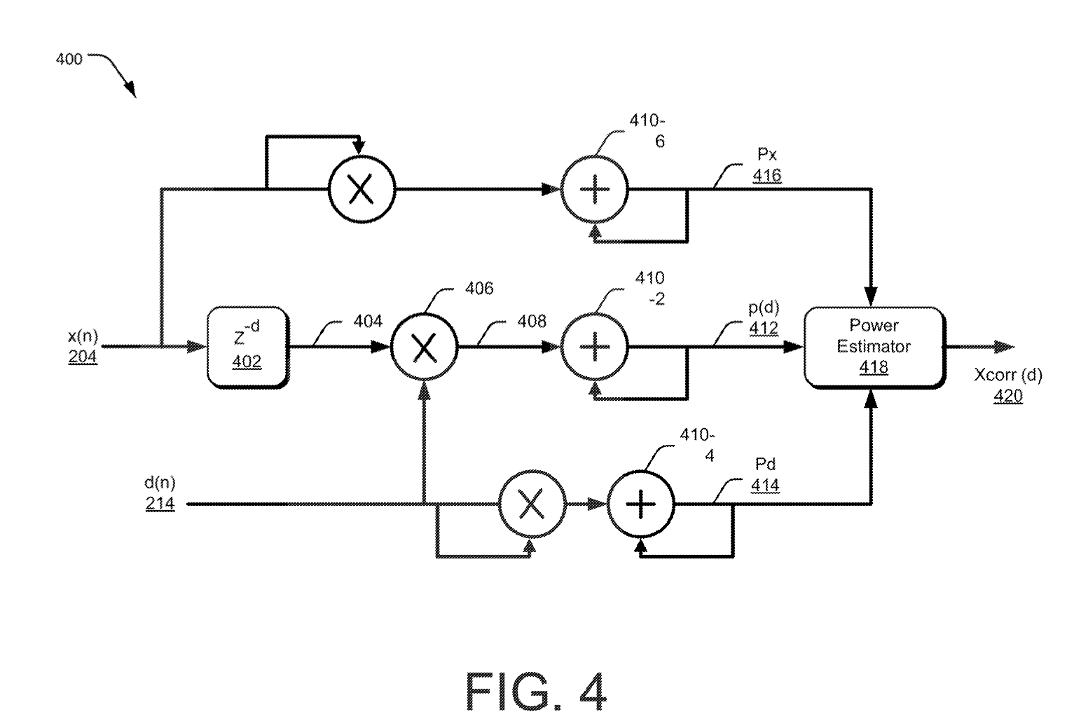

FIG. 4 illustrates an exemplary cross-correlation estimation 400 that is used to estimate delay at the delay estimator 310. Cross-correlation is a process or means of determining a degree of similarity between two signals, such as the signals x(n) 204 and d(n) 214. In an implementation, the signal x(n) 204 may represent a sample of the audio electrical signal from the far-end device 102-2, which is delayed by an amount z^{-d} 402 before being cross-correlated or compared with the signal d(n) 214. In this implementation, the z^{-d} 402 may include the incremental time, such as the step size used on the first and second searches as discussed above. In other words, for the first search, a unit delay z^{-d} 402 may include 6.25 msecs while the unit delay z^{-d} 402 for the second search may include 62.5 μsec. As a result, an output 404 may include a delayed value sample of the x(n) 204 that is cross-correlated with the signal d(n) 214 through a cross-correlation component 406. The cross-correlation component 406 may provide an output 408 that is received by an adder component 410-2. The adder component 410-2 may sum up the output 408 at each unit delay of z^{-d} 402 until the first search and/or the second search is performed to create an output p(d) 412. The p(d) 412 may be equal to total power of the different cross-correlations between the signals x(n) 204 and d(n) 214 after the first search or the second search is performed.

During implementation of the first search or the second search, a power of sampled signal d(n) 214 is summed up by an adder 410-4 to provide an output Pd 414 while a power of sampled signal x(n) 204 is summed up by an adder 410-6 to provide an output Px. 416. The P(d) 414 may include total power reference from the signal d(n) 214 as part of the algorithm that is implemented by the delay estimator 310. Similarly, output Px 416 may include total power reference from the signal x(n) 204 as part of the algorithm that is implemented by the delay estimator 310. In an implementation, a power estimator 418 may estimate delay by determining ratio of the P(d) 414 to the square root of the product of the Px 416 and the Pd 414. In this implementation, the power estimator 418 provides a cross-correlation output (i.e., Xcorr(d) 420) that includes a maximum peak cross-correlations between functions of the signals x(n) 204 and d(n) 214 to determine the estimated delay (e.g., delay 312 in FIG. 3).

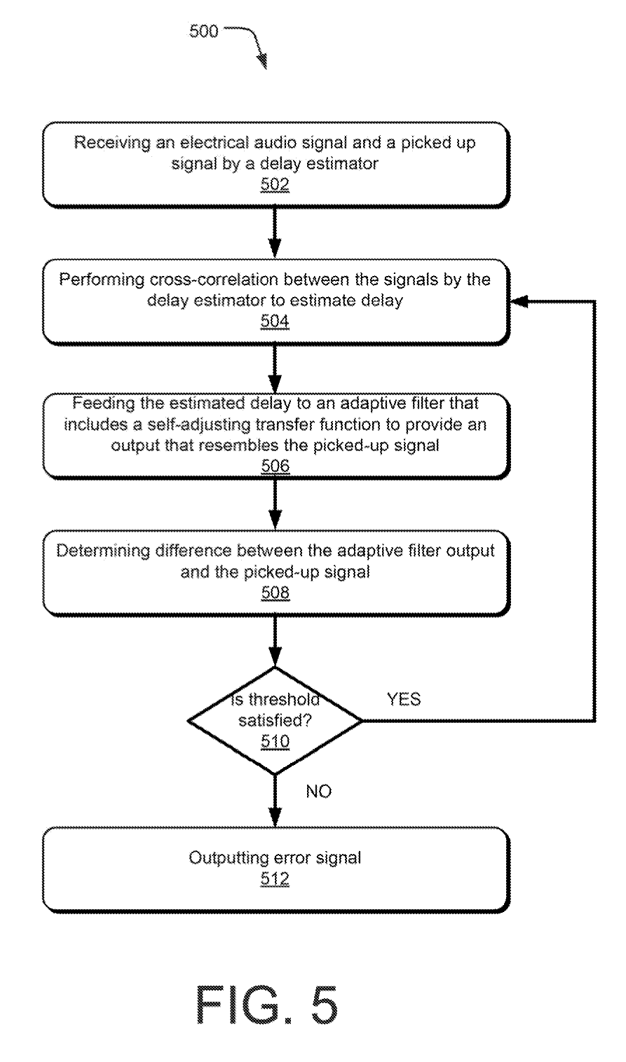

FIG. 5 shows an example process chart 500 illustrating an example method for implementing echo cancellation algorithm for long delayed echo. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention. For example, a computer accessible medium may implement the echo cancellation algorithm for the long delayed echo in the device 102.

At block 502, receiving an electrical audio signal and a picked-up signal by a delay estimator is performed. In an implementation, the delay estimator (e.g., delay estimator 310) may receive the electrical audio signal (e.g., x(n) 204) and the picked-up signal (e.g., d(n) 214) to estimate amount of delay that includes a delay due to a WiFi link (e.g., WiFi link 306) and channel multipath signals (e.g., audio sound signal signal 308).

At block 504, a cross-correlation is performed between the electrical audio signal and the picked up signal by the delay estimator to estimate delay. In an implementation, the delay estimator 310 may perform cross-correlation algorithm to estimate the delay created by the WiFi link 306 and the audio sound signal 308. For example, a first search (e.g., coarse search) is performed at a step size of 6.25 msecs (e.g., z^{-d} 402 is 6.25 msecs) to find a peak value that includes an initial estimate of the estimated delay. In this example, a second search (e.g., fine search) is performed at a step size of 62.5 μs (e.g., z^{-d} 402 is 62.5 μs) to find the final estimate (e.g., delay 312) created by the WiFi link 306 and the audio sound signal 308.

At block 506, feeding the estimated delay to an adaptive filter is performed. In an implementation, a delay insertion component (e.g., delay insertion 314) may be implemented as an interface between the delay estimator 310 and an adaptive filter component (e.g., adaptive filter component 202). In this implementation, the adaptive filter component 202 may include a self-adjusting transfer function to provide an output (e.g., y(n) 216) that closely resembles the value of the picked-up signal d(n) 214.

At block 508, determining difference between the output of the adaptive filter component and the pick-up signal is performed. In an implementation, a differential component (e.g., differential component 218) may subtract the output y(n) 216 from the picked-up signal d(n) 214.

At block 510, determining if threshold value is satisfied is performed. In an implementation, the differential component 218 may provide an error output (e.g., e(n) 220) that is compared to a threshold value for performing another delay estimation. For example, if the error output e(n) 220 exceeds the threshold value (e.g., 0.01), then following YES at block 504, another cross-correlation is performed to estimate delay by the delay estimator 310. Otherwise, following NO at block 512, the error output e(n) 220 is provided to far-end talker (e.g., far-end talker 102-2), which includes a completely cancelled echo signal if the error output e (n) 220 is zero value. In an implementation, the delay estimator 210 may not have to perform the cross-correlation continuously since a near-end environment do not vary (i.e., delay profile of the environment is almost constant).

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

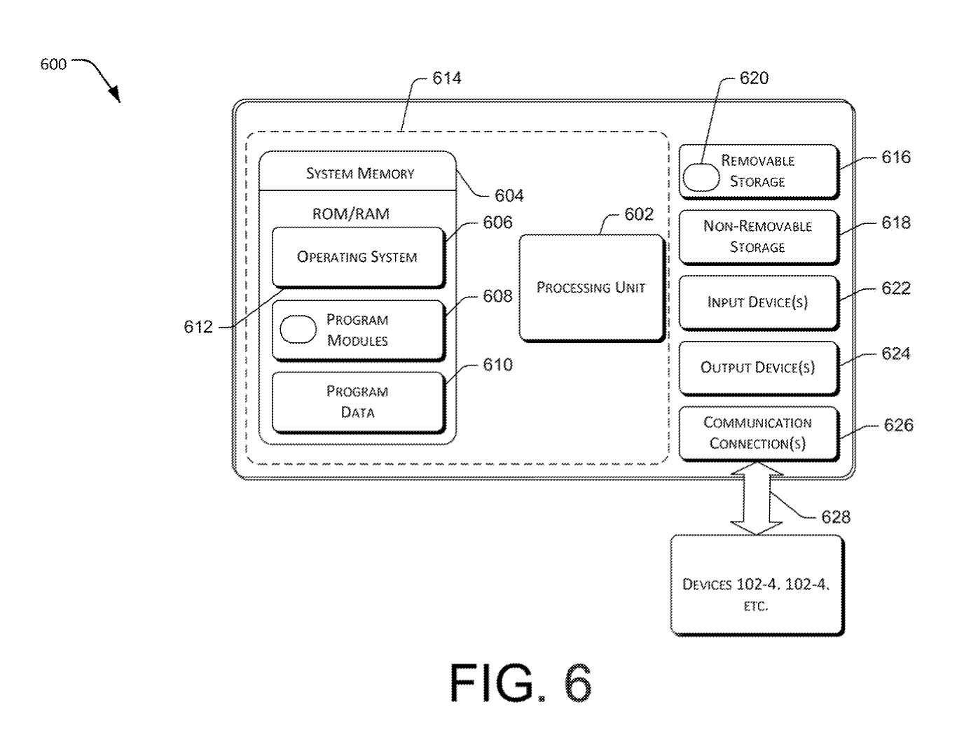

FIG. 6 is an example system that may be utilized to implement various described embodiments. However, it will be readily appreciated that the techniques disclosed herein may be implemented in other computing devices, systems, and environments. The computing device 600 shown in FIG. 6 is one example of a computing device and is not intended to suggest any limitation as to the scope of use or functionality of the computer and network architectures.

In at least one implementation, computing device 600 typically includes at least one processing unit 602 and system memory 604. Depending on the exact configuration and type of computing device, system memory 604 may be volatile (such as RAM), non-volatile (such as ROM, flash memory, etc.) or some combination thereof. System memory 604 may include an operating system 606, one or more program modules 608 that implement the long delay echo algorithm, and may include program data 610. A basic implementation of the computing device 600 is demarcated by a dashed line 614.

The program module 608 may include a module 612 configured to implement the one-tap connection and synchronization scheme as described above. For example, the module 612 may carry out one or more of the method 500, and variations thereof, e.g., the computing device 600 acting as described above with respect to the device 102.

Computing device 600 may have additional features or functionality. For example, computing device 600 may also include additional data storage devices such as removable storage 616 and non-removable storage 618. In certain implementations, the removable storage 616 and non-removable storage 618 are an example of computer accessible media for storing instructions that are executable by the processing unit 602 to perform the various functions described above. Generally, any of the functions described with reference to the figures may be implemented using software, hardware (e.g., fixed logic circuitry) or a combination of these implementations. Program code may be stored in one or more computer accessible media or other computer-readable storage devices. Thus, the processes and components described herein may be implemented by a computer program product. As mentioned above, computer accessible media includes volatile and non-volatile, removable and non-removable media implemented in any method or technology for storage of information, such as computer readable instructions, data structures, program modules, or other data. The terms “computer accessible medium” and “computer accessible media” refer to non-transitory storage devices and include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium that may be used to store information for access by a computing device, e.g., computing device 600 and wireless mobile device 102. Any of such computer accessible media may be part of the computing device 600.

In one implementation, the removable storage 616, which is a computer accessible medium, has a set of instructions 630 stored thereon. When executed by the processing unit 602, the set of instructions 630 cause the processing unit 602 to execute operations, tasks, functions and/or methods as described above, including method 500 and any variations thereof.

Computing device 600 may also include one or more input devices 620 such as keyboard, mouse, pen, voice input device, touch input device, etc. Computing device 600 may additionally include one or more output devices 622 such as a display, speakers, printer, etc.

Computing device 600 may also include one or more communication connections 624 that allow the computing device 600 to communicate wirelessly with one or more other wireless devices, over wireless connection 628 based on near field communication (NFC), Wi-Fi, Bluetooth, radio frequency (RF), infrared, or a combination thereof.

It is appreciated that the illustrated computing device 600 is one example of a suitable device and is not intended to suggest any limitation as to the scope of use or functionality of the various embodiments described.

Unless the context indicates otherwise, the term “Universal Resource Identifier” as used herein includes any identifier, including a GUID, serial number, or the like.

In the above description of example implementations, for purposes of explanation, specific numbers, materials configurations, and other details are set forth in order to better explain the present invention, as claimed. However, it will be apparent to one skilled in the art that the claimed invention may be practiced using different details than the example ones described herein. In other instances, well-known features are omitted or simplified to clarify the description of the example implementations.

The inventors intend the described example implementations to be primarily examples. The inventors do not intend these example implementations to limit the scope of the appended claims. Rather, the inventors have contemplated that the claimed invention might also be embodied and implemented in other ways, in conjunction with other present or future technologies.

Moreover, the word “example” is used herein to mean serving as an example, instance, or illustration. Any aspect or design described herein as “example” is not necessarily to be construed as preferred or advantageous over other aspects or designs. Rather, use of the word example is intended to present concepts and techniques in a concrete fashion. The term “techniques”, for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more”, unless specified otherwise or clear from context to be directed to a singular form.

These processes are illustrated as a collection of blocks in a logical flow graph, which represents a sequence of operations that may be implemented in mechanics alone or a combination with hardware, software, and/or firmware. In the context of software/firmware, the blocks represent instructions stored on one or more computer-readable storage media that, when executed by one or more processors, perform the recited operations.

Note that the order in which the processes are described is not intended to be construed as a limitation, and any number of the described process blocks may be combined in any order to implement the processes or an alternate process. Additionally, individual blocks may be deleted from the processes without departing from the spirit and scope of the subject matter described herein.

The term “computer-readable media” includes computer-storage media. In one embodiment, computer-readable media is non-transitory. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

Unless the context indicates otherwise, the term “logic” used herein includes hardware, software, firmware, circuitry, logic circuitry, integrated circuitry, other electronic components and/or a combination thereof that is suitable to perform the functions described for that logic.

The following examples pertain to further embodiments. A device comprising: a wireless display (WiDi) component adapted to transmits an electrical audio signal through a wireless link, wherein the electrical audio signal is transformed into an audio sound signal that is received by the device; a delay estimator component adapted to perform cross-correlation between the electrical audio signal and the received audio sound signal to estimate total delay, wherein the total delay includes a delay due to the wireless link and multipath delay traversed by the received audio sound signal; a delay insertion component adapted to insert the estimated total delay to an adaptive filter for echo cancellation; and an adaptive filter configured to perform echo cancellation algorithm.

In certain implementations, a device wherein the electrical audio signal is received from a far-end device through a wired or wireless communication channel.

In certain implementations, a device wherein the electrical audio signal is transmitted by the WiDi component to a WiDi compatible display device using the wireless link.

In certain implementations, a device wherein the delay estimator component performs the cross-correlation by implementing a first coarse search to find a peak cross-correlation.

In certain implementations, a device wherein the delay estimator component performs the cross-correlation on the peak cross-correlation due to the first coarse search, wherein the cross-correlation is implemented by a second fine search that includes a unit delay that is smaller than the unit delay that is used in the first coarse search.

In certain implementations, a device wherein the delay estimator component performs the cross-correlation on the peak cross-correlation due to the first coarse search, wherein the cross correlation is implemented by a second fine search that includes a different and/or lesser number of samples than the samples used on the first coarse search.

In certain implementations, a device wherein the delay insertion component acts as an interface between the delay estimator and the adaptive filter.

In certain implementations, a device wherein the adaptive filter implements a transfer function that includes a short tail length.

In certain implementations, a device wherein the adaptive filter includes a configured threshold value to determine whether another delay estimation is performed.

In certain implementations, a device wherein the adaptive filter includes an output that resembles the picked-up audio sound signal.

A method of implementing echo cancellation algorithm for long delayed echo in a device comprising: receiving an electrical audio signal and a picked-up signal, wherein the picked-up signal includes an additional delay due to a wireless display (WiDi) feature of the device; performing cross-correlation between the electrical audio signal and the picked-up signal to estimate delay; feeding the estimated delay to an adaptive filter; determining difference between an output of the adaptive filter and the picked-up signal; and outputting an error signal that includes the difference between the output of the adaptive filter and the picked-up signal.

In certain implementations, a method wherein the electrical audio signal is streamed by a WiDi component through a wireless link, wherein the wireless link, includes a path for the additional delay.

In certain implementations, a method wherein the cross-correlation is performed by implementing a first search to find a peak cross-correlation that includes an initial estimated delay.

In certain implementations, a method wherein the cross-correlation is performed on the peak cross-correlation to find the estimated delay, wherein the cross-correlation uses a second search that includes a unit delay that is smaller than the unit delay that is used in the first search.

In certain implementations, a method wherein the cross-correlation is not continuously performed since a near-end environment do not vary.

In certain implementations, a method wherein the cross-correlation is performed when the difference between the output of the adaptive filter and the picked-up signal is greater than a configured threshold value.

In certain implementations, a method wherein the output of the adaptive filter is derived by using least mean squares (LMS) algorithm, normalized LMS (NLMS) algorithm, or root mean square (RMS) algorithm.

In certain implementations, a method wherein the adaptive filter implements a transfer function that includes a short tail length.

In certain implementations, a method wherein the adaptive filter includes the output that resembles the picked-up signal to satisfy a configured threshold value.

In certain implementations, a method further comprising self-adjusting a transfer function by the adaptive filter according to an optimization algorithm that is driven by the error signal.

At least one computer accessible medium that performs a method of implementing echo cancellation algorithm for long delayed echo comprising: receiving an electrical audio signal and a picked-up signal by a device; performing cross-correlation between the electrical audio signal and the picked-up signal to estimate delay, wherein the estimated delay includes an additional delay in a wireless path that is used by a wireless display (WiDi) feature of the device; sending the estimated delay to an adaptive filter; determining an error signal that includes difference between an output of the adaptive filter and the picked-up signal; and outputting the error signal that is below a threshold value, wherein the threshold value indicates cancellation of the long delayed echo.

In certain implementations, a computer accessible medium wherein the electrical audio signal is streamed by the WiDi feature of the device to display device through the wireless path, wherein the display device transforms the electrical audio signal to an audio sound signal that is picked-up by the device.

In certain implementations, a computer accessible medium wherein the cross-correlation is performed by implementing a first coarse search to find a peak cross-correlation that includes an initial estimated delay.

In certain implementations, a computer accessible medium wherein the cross-correlation is performed on the peak cross-correlation to find final estimated delay, wherein the cross-correlation uses a second fine search that includes a unit delay that is smaller than the unit delay that is used in the first coarse search.

In certain implementations, a computer accessible medium wherein the cross-correlation is performed when a threshold value is not satisfied.

In certain implementations, a computer accessible medium wherein the output of the adaptive filter is derived by using least mean squares (LMS) algorithm, normalized LMS (NLMS) algorithm, or root mean square (RMS) algorithm.

In certain implementations, a computer accessible medium wherein the adaptive filter implements a transfer function that includes a short tail length.

In certain implementations, a computer accessible medium wherein the adaptive filter includes the output that resembles the picked-up signal to satisfy a configured threshold value.

In certain implementations, a computer accessible medium further comprising comparing the difference in a differential component to a configured threshold value.

In certain implementations, a computer accessible medium further comprising self-adjusting a transfer function by the adaptive filter according to an optimization algorithm that is driven by the error signal.

1-31. (canceled)

32. A device comprising:
a wireless display (WiDi) component adapted to transmit an electrical audio signal through a wireless link, wherein the electrical audio signal is transformed into a transmitted audio sound signal by the device;
a delay estimator component adapted to perform cross-correlation between the electrical audio signal and the transmitted audio sound signal to estimate total delay, wherein the total delay includes a delay due to the wireless link and multipath delay traversed by the transmitted audio sound signal;
an adaptive filter configured to perform an echo cancellation of the transmitted audio sound signal; and
a delay insertion component adapted to insert the estimated total delay to the adaptive filter for echo cancellation.

33. The device as recited in claim 32, wherein the electrical audio signal is received from a far-end device through a wired or wireless communication channel.

34. The device as recited in claim 32, wherein the delay estimator component performs the cross-correlation by implementing a first coarse search to find a peak cross-correlation.

35. The device as recited in claim 32, wherein the delay estimator component performs the cross-correlation on a peak cross-correlation due to a first coarse search, wherein the cross-correlation is implemented by a second fine search that includes a unit delay that is smaller than the unit delay that is used in the first coarse search.

36. The device as recited in claim 32, wherein the delay estimator component performs the cross-correlation on a peak cross-correlation due to a first coarse search, wherein the cross correlation is implemented by a second fine search that includes a different and/or lesser number of samples than the samples used on the first coarse search.

37. The device as recited in claim 32, wherein the delay insertion component acts as an interface between the delay estimator and the adaptive filter.

38. The device as recited in claim 32, wherein the adaptive filter includes a configured threshold value to determine whether another delay estimation is performed.

39. The device as recited in claim 32, wherein the device is part of a system that includes a microphone and/or audio sensor.

40. A method of implementing echo cancellation algorithm for long delayed echo in a device comprising:
receiving an electrical audio signal and a picked-up signal, wherein the picked-up signal includes an additional delay due to a wireless display (WiDi) feature of the device;
performing cross-correlation between the electrical audio signal and the picked-up signal to estimate delay;
feeding the estimated delay to an adaptive filter;
determining difference between an output of the adaptive filter and the picked-up signal; and
outputting an error signal that includes the difference between the output of the adaptive filter and the picked-up signal.

41. The method as recited in claim 40, wherein the cross-correlation is performed by implementing a first search to find a peak cross-correlation that includes an initial estimated delay.

42. The method as recited in claim 40, wherein the cross-correlation is performed on a peak cross-correlation to find the estimated delay, wherein the cross-correlation uses a second search that includes a unit delay that is smaller than the unit delay that is used in a first search.

43. The method as recited in claim 40, wherein the cross-correlation is performed when the difference between the output of the adaptive filter and the picked-up signal is greater than a configured threshold value.

44. The method as recited in claim 40, wherein the adaptive filter implements a transfer function that includes a short tail length.

45. The method as recited in claim 40, wherein the adaptive filter includes the output that resembles the picked-up signal to satisfy a configured threshold value.

46. At least one computer accessible medium that performs a method of implementing echo cancellation algorithm for long delayed echo comprising:
receiving an electrical audio signal and a picked-up signal by a device;
performing cross-correlation between the electrical audio signal and the picked-up signal to estimate delay, wherein the estimated delay includes an additional delay in a wireless path that is used by a wireless display (WiDi) feature of the device;
sending the estimated delay to an adaptive filter;
determining an error signal that includes difference between an output of the adaptive filter and the picked-up signal; and
outputting the error signal that is below a threshold value, wherein the threshold value indicates cancellation of the long delayed echo.

47. A computer accessible medium as recited in claim 46, wherein the electrical audio signal is streamed by the WiDi feature of the device to display device through the wireless path, wherein the display device transforms the electrical audio signal to an audio sound signal that is picked-up by the device.

48. A computer accessible medium as recited in claim 46, wherein the cross-correlation is performed by implementing a first coarse search to find a peak cross-correlation that includes an initial estimated delay.

49. A computer accessible medium as recited in claim 46, wherein the cross-correlation is performed on a peak cross-correlation to find final estimated delay, wherein the cross-correlation uses a second fine search that includes a unit delay that is smaller than the unit delay that is used in a first coarse search.

50. A computer accessible medium as recited in claim 46, wherein the cross-correlation is performed when a threshold value is not satisfied.

51. A computer accessible medium as recited in claim 46, wherein the adaptive filter implements a transfer function that includes a short tail length.
